(19) United States
(12) Patent Application Publication
(10) Pub. No.: US 2010/0312631 A1
(43) Pub. Date: Dec. 9, 2010

(54) COUPON CARD KIOSK

(76) Inventor: Karen L. Cervenka, Belmont, CA (US)

Correspondence Address: Quarles & Brady LLP, TWO NORTH CENTRAL AVENUE, One Renaissance Square, PHOENIX, AZ, 85004-2391, US

(21) Appl. No.: 12/480,444

(22) Filed: Jun. 8, 2009

(51) Int. Cl. G06Q 30/00; G06Q 20/00; G06K 19/00

(52) U.S. Cl. 705/14.37; 705/21; 705/30; 235/487

(57) ABSTRACT

A method for providing an electronic coupon to a user of a kiosk is disclosed. The method includes receiving, via an input device of a user interface, a selection of an electronic coupon from a database. Each electronic coupon in the database is associated with a sponsor's account and can be used to receive a discount on a purchase from a merchant, where the discount is debited from the sponsor's account and credited to the merchant's. From the database, the kiosk retrieves a rendering image corresponding to the rendering capabilities of the kiosk and a memory location to store the discount information, and the discount information. The discount information includes identifiers for the sponsor's account, the discount amount, and the purchase eligible for the discount. The discount information is written to the portable coupon device and it is dispensed. Finally, a hard copy of the rendering image is rendered.

### CROSS NOTING

The case is filed concurrently with U.S. patent application Ser. No. ______, by Karen Cervenka, titled Coupon Card Generation Web Service, and with U.S. patent application Ser. No. ______, by Karen Cervenka, titled Transaction Handler Merchant Reimbursement For Consumer Transaction Use Of Sponsor Discount Coupon Card, and with U.S. patent application Ser. No. ______, by Karen Cervenka, titled Transaction Handler Merchant Reimbursement For Consumer Transaction Use Of Sponsor Discount Coupon Card, and with U.S. patent application Ser. No. ______, by Karen Cervenka, titled Coupon Card Point Of Service Terminal Processing, each of which is incorporated herein by reference.

### FIELD

The present invention is related to a transaction between a merchant and a consumer, is more particularly related to a discount on such a transaction, and is most particularly related to a coupon being presented by the consumer to the merchant to obtain the discount on the transaction.

### BACKGROUND

The present invention relates generally to the distribution of coupons, and more particularly to the distribution of electronic coupons stored on a coupon card via a kiosk, the coupon card having stored thereon the account of a coupon sponsor.

Consumers obtain paper coupons in a variety of ways. They may cut them out of a newspaper or receive them at a Point of Service (POS) terminal when making a purchase. Sometimes paper coupons are mailed to consumers by the sponsor of the coupon or other entity. Each of these distribution methods, however, are associated recurring costs. Every time a manufacturer or merchant decides to offer a paper coupon they must pay to have them printed and distributed.

Moreover, paper coupons are cumbersome and easily lost. Many consumers spend valuable time clipping the paper coupons they want from newspapers. Those who use a large number of paper coupons often spend additional time sorting the coupons into categories so that a particular coupon is easier to find. Further, customers will often receive the paper coupon some time before they intend to use it. The consumer must then store the paper coupon until they go shopping.

Additionally, consumers may not receive paper coupons for specific items they buy even though the coupons are available from a manufacturer or merchant. The consumer may not be on the mailing list to receive the coupon or it may not have been printed in the newspaper they buy. In some cases this may cause the consumer to forego purchasing a specific item in favor of a less costly alternative.

Thus, there is a need for a system that reduces the costs incurred by merchants and manufacturers in offering coupons as well as that allows consumers to be able to quickly find and obtain the coupons they want.

### SUMMARY

In one implementation, a method for providing an electronic coupon to a user of a kiosk is disclosed. The method includes receiving, via an input device of a user interface, a selection of an electronic coupon from a database. Each electronic coupon in the database is associated with a sponsor account issued to a sponsor of the discount by an issuer and can be used to receive a discount on a purchase from a merchant, where the discount is debited from the sponsor's account and credited to the merchant's. From the database, the kiosk then retrieves a rendering image corresponding to the rendering capabilities of the kiosk and a memory location to store the discount information in the memory of a type of portable coupon device stored within the kiosk, and the discount information. The discount information includes identifiers for the sponsor's account, the discount amount, and the purchase eligible for the discount. The discount information is written to the memory location of the portable coupon device. The portable coupon device is dispensed to the user. A hard copy of the rendering image is also rendered (i.e., printed on paper) and dispensed to the user.

In another implementation, a kiosk is presented. The kiosk includes a user interface, an input device, a means for retrieving, a means for writing, a means for dispensing, and a means for rendering. The user interface is capable of displaying an electronic coupon from a database, where each electronic coupon is associated with a sponsor account issued to a sponsor of the discount by an issuer and can be used to receive a discount on a purchase from a merchant, where the discount is debited from the sponsor's account and credited to the merchant's. The means for retrieving retrieves from the database a rendering image corresponding to the rendering capabilities of the kiosk, a memory location to store discount information in the memory of the portable coupon device, and the discount information, which includes identifiers for the sponsor's account, a discount amount, and the purchase eligible for the discount.

In yet another implementation, a method of using a kiosk to obtain a portable coupon card having an electronic coupon stored thereon is presented. The method includes selecting, using an input device of a user interface, an electronic coupon from a database. Each electronic coupon is associated with a sponsor account issued to a sponsor of the discount by an issuer and can be used to receive a discount on a purchase from a merchant, where the discount is debited from the sponsor's account and credited to the merchant's. Next, from the kiosk, a portable coupon device and a hard copy of a rendering image is received. The portable coupon device has discount information stored in memory which includes identifiers for the sponsor's account, a discount amount, and the purchase that is eligible for the discount.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network, depicting the general environment where a coupon card may be used by a card holder to obtain a discount on a purchase;

FIG. 2 depicts a block diagram of a method of using a kiosk to obtain a coupon card associated with an electronic coupon;

FIG. 3 depicts a flow chart of an exemplary method used by a kiosk to provide a coupon card having an electronic coupon stored thereon to a consumer.

FIG. 4 illustrates possible alternative implementations of the data encoding area of a coupon card;

FIG. 5 depicts the environment within FIG. 1 where a coupon card is used by a consumer to obtain a discount on a purchase.

### DETAILED DESCRIPTION

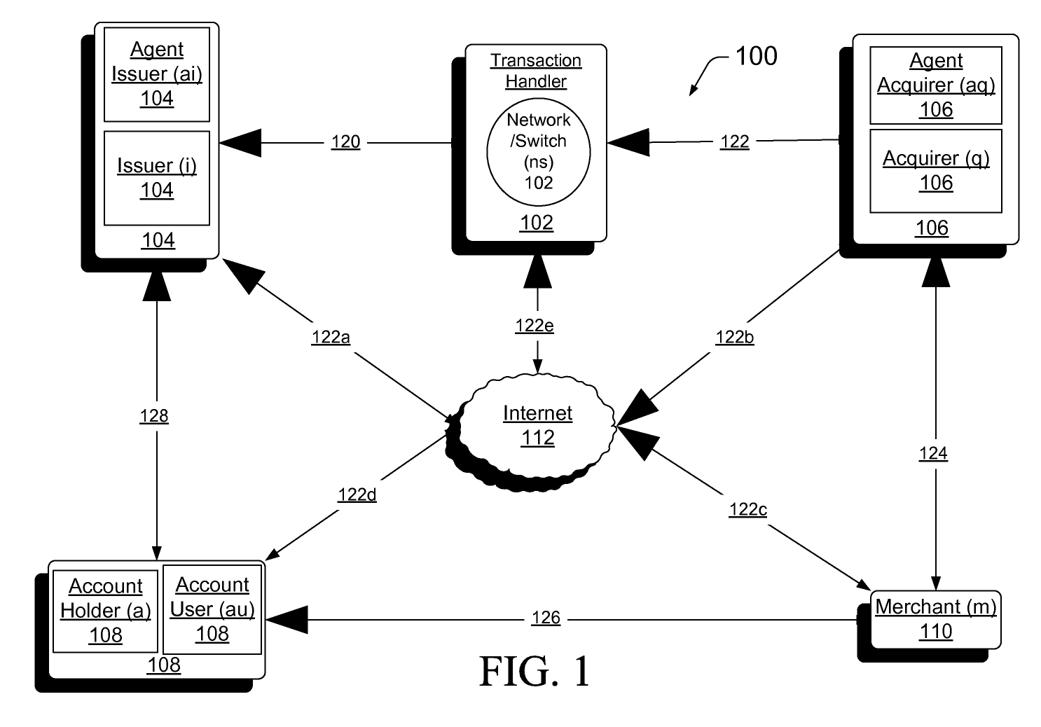

FIG. 1 illustrates an exemplary payment processing system 100, depicting a general environment in which a merchant (m) 110 can conduct a transaction for goods and/or services with an account user (au) on an account (i.e., a prepaid account) issued to an account holder (a) 108 by an issuer (i) 104, where the processes of paying and being paid for the transaction are coordinated by a transaction handler 102. The transaction includes participation from different entities that are each a component of the payment processing system 100.

Payment processing system 100 has a plurality of merchants 110 that includes merchant (1) 110 through merchant (M) 110, where M can be up to and greater than an eight digit integer.

Payment processing system 100 has a plurality of prepaid accounts 108 each of which is held by a corresponding account holder (1) 108 through account holder (A) 108, where A can be up to and greater than a ten eight digit integer.

Payment processing system 100 includes account user (1) 108 through account user (AU) 108, where AU can be as large as a ten digit integer or larger. Each account user (au) conducts a transaction for goods and/or services with merchant (m) 110 using an account (i.e., a prepaid account) that has been issued by an issuer (i) 104 to a corresponding account holder (a) 108. Data from the transaction on the account is collected by merchant (m) and forwarded to a corresponding acquirer (a) 106. Acquirer (a) 106 forwards the data to transaction handler 102 who facilitates payment for the transaction from the prepaid account issued by the issuer (i) 104 to account holder (a) 108.

Payment processing system 100 has a plurality of issuers 104. Each issuer (i) 104 may be assisted in processing one or more transactions by a corresponding agent issuer (ai) 104, where ‘i’ can be an integer from 1 to I, where ‘ai’ can be an integer from 1 to AI, and where I and AI can be as large as an eight digit integer or larger.

Payment processing system 100 has a plurality of acquirers 106. Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as an eight digit integer or larger.

Payment processing system 100 has a transaction handler 102 to process a plurality of transactions. The transaction handler 102 can include one or a plurality or networks and switches 102. Each network/switch (ns) 102 can be a mainframe computer in a geographic location different than each other network/switch (ns) 102, where ‘ns’ is an integer from one to NS, and where NS can be as large as a four digit integer or larger.

Dedicated communication systems 120, 122 (i.e., private communication network(s)) facilitate communication between the transaction handler 102 and each issuer (i) 104 and each acquirer (a) 106. The Internet 112, via e-mail, the World Wide Web, cellular telephony, and/or other optional public and private communications systems, can facilitate communications 122a-122e among and between each issuer (i) 104, each acquirer (a) 106, each merchant (m) 110, each account holder (a) 108, and the transaction handler 102. Alternatively and optionally, one or more dedicated communication systems 124, 126, and 128 can facilitate respective communications between each acquirer (a) 106 and each merchant (m) 110, each merchant (m) and each account holder (a) 108, and each account holder (a) 108 and each issuer (i) 104, respectively.

Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as an eight digit integer or larger.

Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant making a purchase from another merchant (m) 110. Merchant (m) 110 may utilize at least one point-of-sale terminal (POS) that can communicate with acquirer (a) 106, transaction handler 102, or issuer (i) 104. Thus, the POS terminal is in operative communication with the payment processing system 100.

Typically, a transaction begins with account user (au) 108 presenting a portable consumer device to merchant (m) 110 to initiate an exchange for a good or service. The portable consumer device may be associated with an account (e.g., a prepaid account) of account holder (a) 108 that was issued to the account holder (a) 108 by issuer (i) 104.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder (a) 108's name.

Merchant (m) 110 may use the POS terminal to obtain account information, such as a number of the account of the account holder (a) 108, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 104 of the account corresponding to the portable consumer device. Alternatively, or in combination, the portable consumer device may communicate with issuer (i) 104, transaction handler 102, or acquirer (a) 106.

Issuer (i) 104 may authorize the transaction using transaction handler 102. Transaction handler 102 may also clear the transaction. Authorization includes issuer (i) 104, or transaction handler 102 on behalf of issuer (i) 104, authorizing the transaction in connection with issuer (i) 104's instructions such as through the use of business rules. The business rules could include instructions or guidelines from transaction handler 102, account holder (a) 108, merchant (km) 110, acquirer (a) 106, issuer (i) 104, a related financial institution, or combinations thereof. Transaction handler 102 may maintain a log or history of authorized transactions. Once approved, merchant (m) 110 will record the authorization, allowing account user (au) 108 to receive the good or service from merchant (m) or an agent thereof.

Merchant (m) 110 may, at discrete periods, such as the end of the day, submit a list of authorized transactions to acquirer (a) 106 or other transaction related data for processing through the payment processing system 100. Transaction handler 102 may compare the submitted authorized transaction list with its own log of authorized transactions. If a match is found, transaction handler 102 may route authorization transaction amount requests from the corresponding acquirer (a) 106 to the corresponding issuer (i) 104 involved in each transaction. Once acquirer (a) 106 receives the payment of the authorized transaction amount from issuer (i) 104, acquirer (a) 106 can forward the payment to merchant (m) 110 less any transaction costs, such as fees for the processing of the transaction. If the transaction involves a debit or pre-paid card, acquirer (a) 106 may choose not to wait for the issuer (i) 104 to forward the payment prior to paying merchant (m) 110.

There may be intermittent steps in the foregoing process, some of which may occur simultaneously. For example, acquirer (a) 106 can initiate the clearing and settling process, which can result in payment to acquirer (a) 106 for the amount of the transaction. Acquirer (a) 106 may request from transaction handler 102 that the transaction be cleared and settled. Clearing includes the exchange of financial information between the issuer (i) 104 and the acquirer (a) 106 and settlement includes the exchange of funds. Transaction handler 102 can provide services in connection with settlement of the transaction. The settlement of a transaction includes depositing an amount of the transaction settlement from a settlement house, such as a settlement bank, which transaction handler 102 typically chooses, into a clearinghouse, such as a clearing bank, that acquirer (a) 106 typically chooses. Issuer (i) 104 deposits the same from a clearinghouse, such as a clearing bank, which issuer (i) 104 typically chooses, into the settlement house. Thus, a typical transaction involves various entities to request, authorize, and fulfill processing the transaction.

Payment processing system 100 will preferably have network components suitable for scaling the number and data payload size of transactions that can be authorized, cleared and settled in both real time and batch processing. These include hardware, software, data elements, and storage network devices for the same. Examples of payment processing system 100 include those operated, at least in part, by American Express, Master Card, Discover Card, First Data Corporation, Diners Club, and Visa Inc., and agents of the foregoing.

Each network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (i.e., one or more IBM mainframe computers) for communications over systems 120, 122, one or more server farms (i.e., one or more Sun UNIX Superservers), where the mainframe computers and server farms can be in diverse geographic locations.

Each issuer (i) 104 (or agent issuer (ai) 104 thereof) and each acquirer (a) 106 (or agent acquirer (aq) 106 thereof) can use one or more router/switch (i.e., Cisco routers/switches) to communicate with each network/switch (ns) 102 via dedicated communication systems 120, 122, respectively.

Transaction handler 102 stores information about transactions processed through payment processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 100 over paying and being paid by cash, checks, or other traditional payment mechanisms.

The VisaNet® system is an example component of the transaction handler 102 in the payment processing system 100. Presently, the VisaNet® system is operated in part by Visa Inc. As of 2007, the VisaNet® system Inc. was processing around 300 million transactions daily, on over 1 billion accounts used in over 170 countries. Financial instructions numbering over 16,000 connected through the VisaNet® system to around 30 million merchants. In 2007, around 81 billion transactions for about 4 trillion U.S. dollars were cleared and settled through the VisaNet® system, some of which involved a communication length of around 24,000 miles in around two (2) seconds.

In the present context, an account for the payment of future discounts on goods and services attributable to the use of electronic coupons is issued by the issuer to a third-party and credited with funds submitted by the third-party. The funds are for reimbursement of discounts on the sale of goods and services given by a merchant upon the presentation of a coupon card having at least one of the electronic coupons stored thereon.

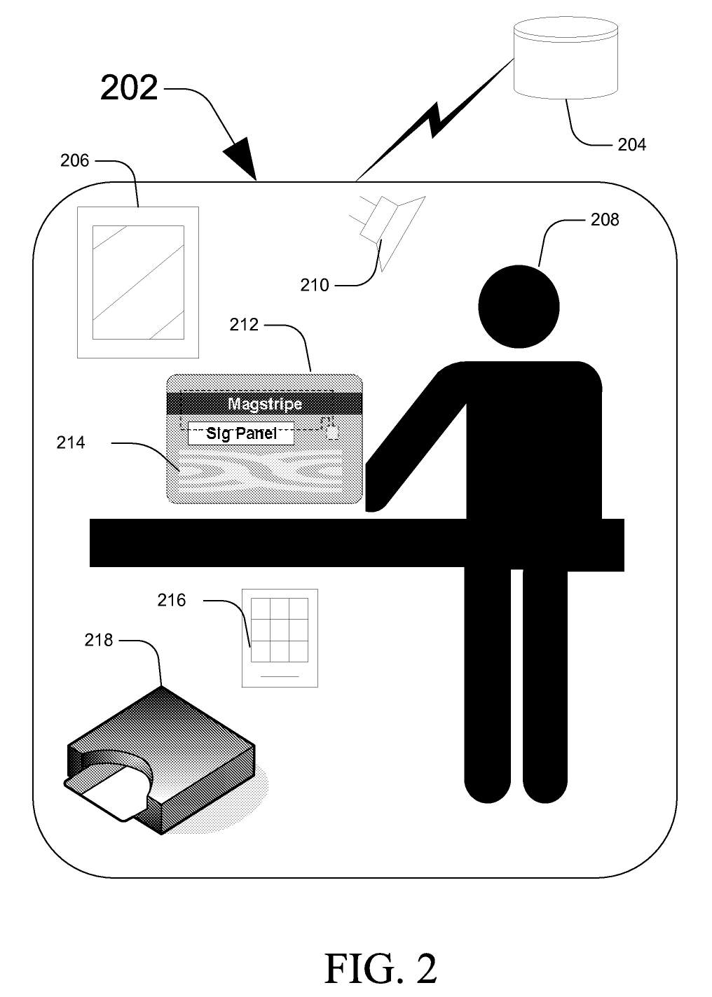

FIG. 2 depicts a block diagram of a kiosk 202 that can be used by a user 208 to obtain a coupon card associated with at least one electronic coupon issued by a third-party and capable of being used in payment processing system 100 (FIG. 1) to obtain a discount on a transaction between a consumer (i.e., the user 208) and a merchant. Although the implementation is discussed in regards to a substantially planar laminated card, one skilled in the art will recognize that other forms of transaction tokens or portable consumer payment devices could be used in the disclosed method.

The kiosk itself is in communication with a database 204 that is capable of storing and relating information regarding the available electronic coupons. In one implementation, a third-party sponsoring at least one electronic coupon has access to database 204 and may send to and receive from database 204 information such as, without limitation, the number of electronic coupons used, the number of electronic coupons remaining, or any other relevant information. In certain implementations, database 204 may be stored on one or more network devices on a network. In such implementations, the kiosk is capable of connecting to a network using one or more network communications protocols as are known in the art.

In use of kiosk 202, consumer 208 is presented with a selection of electronic coupons by a user interface 206 of the kiosk 202. User interface 206 may be a touch screen, a digital electronic display, a projector, a monitor, any combination of the foregoing, or any other device for the presentation of information. Additionally, the kiosk may have a speaker 210 or other device capable of providing instructions and information to consumer 208.

In certain implementations, the selection of electronic coupons presented to consumer 208 is customized to consumer 208. By way of example and not limitation, in such implementations, the customization may be based upon known shopping habits of consumer 208, the location where consumer 208 lives, the location of the kiosk, and/or a type of financial transaction token provided by consumer 208. In certain implementations, consumer 208 provides identifying information to the kiosk, for example and without limitation, a zip code, name, financial transaction token, or driver's license. Consumer 208 may provide this information using input device 216. In other implementations, consumer 208 may provide the identifying information via device 218 where the information is stored on a financial transaction token, driver's license, or other similar device.

Consumer 208 selects an electronic coupon using an input device 216. The input device 216 may be a key pad, a touch screen, a pointing device, an audio input device, a video input device, any combination of the foregoing, or other hardware capable of receiving and transforming data for use by the kiosk 202.

In one implementation, consumer 208 receives from the kiosk 202 a coupon card 212 via device 218, which is both a transaction token reader and a card producer. In other implementations, consumer 208 may receive the coupon card 212 via another device. In certain implementations, the kiosk includes a stack of blank coupon cards which, upon enhancement by the kiosk 202 as disclosed herein, may be dispensed by kiosk 202 to consumer 208. In certain implementations, consumer 208 pays a fee for coupon card 212. In such an implementation, consumer 208 may provide a financial transaction token, such as, without limitation, the consumer's credit card or a debit card, to device 218 which, in turn, provide enhancements thereto as disclosed herein.

In other implementations, consumer 208 obtains coupon card 212 and provides it to the kiosk via device 218. In such implementations, consumer 208 may purchase coupon card 212 from a merchant. In other implementations, consumer 208 may receive coupon card 212 from a manufacturer, a merchant, or any other entity having an interest in sponsoring electronic coupons. In yet other implementations, coupon card 212 is also a portable consumer device and is issued by an issuer to consumer 208 (i.e., a credit card, a debit card, a gift card, etc.)

The kiosk 202 write to, or otherwise stores on, coupon card 212 information relating to the electronic coupon selected by consumer 208. In certain implementations, the information is stored in a specific memory location. In such implementations, the memory location may be dependent on the type of coupon card. The information stored in the memory of the coupon card includes the account identifier associated with an account issued by an issuer to the third-party sponsor of the electronic coupon. The account is credited with funds provided by the third-party sponsor to pay for the discount applied when a consumer uses the electronic coupon. In certain implementations, the information further includes the item or type of item for which the electronic coupon is valid. By way of example, and not by way of limitation, the electronic coupon may be valid for all cleaning products made by a particular manufacturer. Alternatively, the coupon may be valid for a specific dish soap produced by the manufacturer in only a particular size, weight, or quantity.

In certain implementations, the information includes a merchant or manufacturer with which the electronic coupon is valid. In such an implementation, the electronic coupon may be valid for use only with a particular merchant or only for purchase of a particular manufacturer's product. In other implementations, the information includes an expiration date, after which the electronic coupon is no longer valid. In yet other implementations, the information includes the number of goods or services eligible for a discount using the electronic coupon. By way of example and not limitation, the electronic coupon may be valid for discounts on up to three (3) bottles of a pain reliever. Alternatively, the electronic coupon may only be used when ten (10) car washes are purchased at the same time.

The information may be stored on coupon card 212 using a magnetic strip, a memory portion of an integrated circuit, a contactless data communication device, a combination of any of the foregoing, or any other known device or method of storing information on a card or equivalent thereof that will be developed.

In certain implementations, the selected electronic coupon may also be associated with a bar code identifying the item or type of item for which the electronic coupon is valid. As will be understood by one of ordinary skill in the art, a bar code is an optical machine-readable representation of data. In certain implementations, the bar code uses Universal Product Code (UPC) symbology. In such an implementation, the bar code is capable of being rendered on a print-out by a printer associated with the kiosk. The print-out may then later be scanned by a scanner at a POS terminal to identify the type of item eligible for a discount using the electronic coupon.

Where consumer 208 receives a print-out in addition to coupon card 212, the print-out may include an identifier of the item or type of item eligible for a discount. The identifier then acts as a reminder to consumer 208 of the electronic coupon that was downloaded. In certain implementations, the identifier is a picture of the discounted item. In other implementations, the identifier is a text description of the discounted item. In certain implementations, the identifier is a combination of a text description and a picture.

In certain implementations, the print-out may additionally include an advertisement. In certain implementations, the advertisement is for a soon-to-be-available coupon. In certain implementations, the print-out may additionally include a map having directions from the kiosk to merchant locations, where the electronic coupon can be used. Where the kiosk is located in a mall or similar shopping establishment, the map may be a walking map. The map may be obtain by the kiosk 202, for instance, by communicating to a mapping Internet or web service the location of a merchant corresponding to a user-selected coupon and the kiosk's geographic location, where the kiosk 202 is then served the map from the mapping web or Internet service.

In one implementation, the kiosk 202 is additionally capable of printing an image 214 on coupon card 212. To achieve such functionality, the kiosk may contain a card printer such as, for example, the Direct-to-Card (DTC) 550 or High Definition Printing (HDP) 5000 commercially available from Fargo Electronics, Inc., a corporation located in Eden Prairie, Minn. In certain implementations, image 214 is an advertisement. In certain implementations, image 214 is an advertisement that is associated with at least one electronic coupon stored on coupon card 212.

It will be apparent to an individual of ordinary skill in the relevant art that consumer 208 may use kiosk 202 to store multiple electronic coupons on coupon card 212 at the same time. In such situations, consumer 208 may select different electronic coupons associated with different third-party accounts for storage on coupon card 212. Thus, for example, consumer 208 may select one electronic coupon sponsored by a manufacturer and one electronic coupon sponsored by a merchant for storage on the same coupon card. Alternatively, consumer 208 may select multiple electronic coupons sponsored by a single merchant for storage on one coupon card and then select multiple coupons sponsored by a single manufacturer for storage on another coupon card.

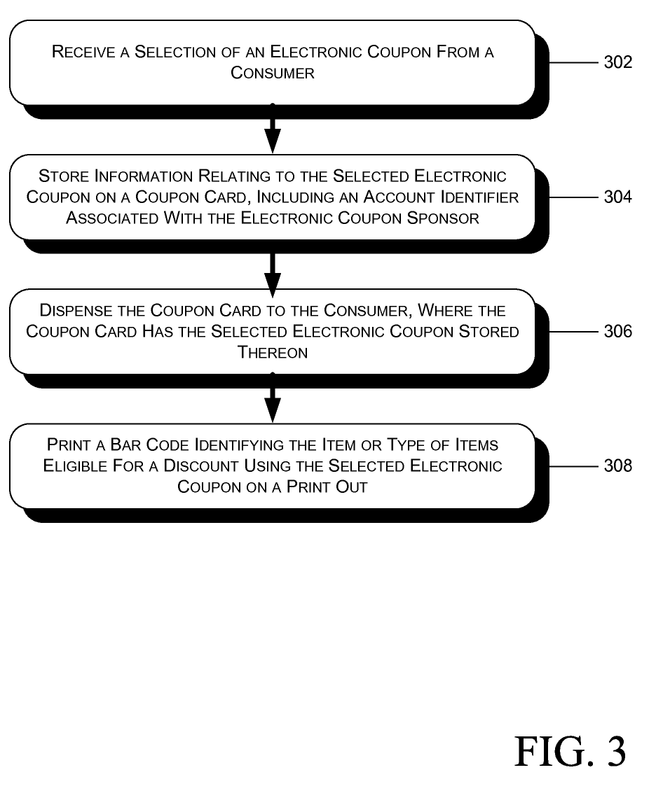

Turning now to FIG. 3, a flow chart of an exemplary method used by a kiosk to provide a coupon card having an electronic coupon stored thereon to a consumer is presented. As indicated by block 302, to start, the kiosk receives a selection of an electronic coupon from a consumer. Next, the kiosk stores information relating to the selected electronic coupon on a blank coupon card, including an account identifier associated with the sponsor of the selected electronic coupon, as indicated by block 304. In certain implementations, the blank coupon card is one of a plurality of blank coupon cards stored in the kiosk. In other implementations, the coupon card is provided by the consumer via an input device to the kiosk. In such an implementation, the coupon card may or may not be blank. Where the coupon card is not blank, the kiosk may add the information for the selected electronic coupon to the prior information stored on the coupon card. In other implementations, the kiosk may overwrite the prior information stored on the coupon card such that any previously stored electronic coupons are deleted. In other implementations, the kiosk may present the consumer with the option of deleting the previously stored electronic coupons or adding the selected electronic coupon to the electronic coupons already stored on the coupon card.

In regards to the coupon card, the kiosk may store may information on a magnetic strip, an integrated circuit, a contactless data communication device, a combination of any of the foregoing, or any other storage medium on a card.

As indicated by block 306, after the information associated with the selected electronic coupon is stored on the coupon card, the coupon card is dispensed to the consumer. Finally, the kiosk prints a bar code identifying the item or type of items eligible for a discount using the selected electronic coupon on a print-out, as indicated by block 308. The print-out is also dispensed by the kiosk to the consumer. In certain implementations, individual steps in FIG. 3. described above may be combined, eliminated, or reordered. In certain implementations, instructions are encoded in computer readable medium wherein those instructions are executed by a processor to perform one or more of the blocks 302, 304, 306, and 308 recited in FIG. 3.

In yet other implementations, the invention includes instructions residing in any other computer program product, where those instructions are executed by a computer external to, or internal to, a computing system to perform one or more of the blocks 302, 304, 306, and 308 recited in FIG. 3. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

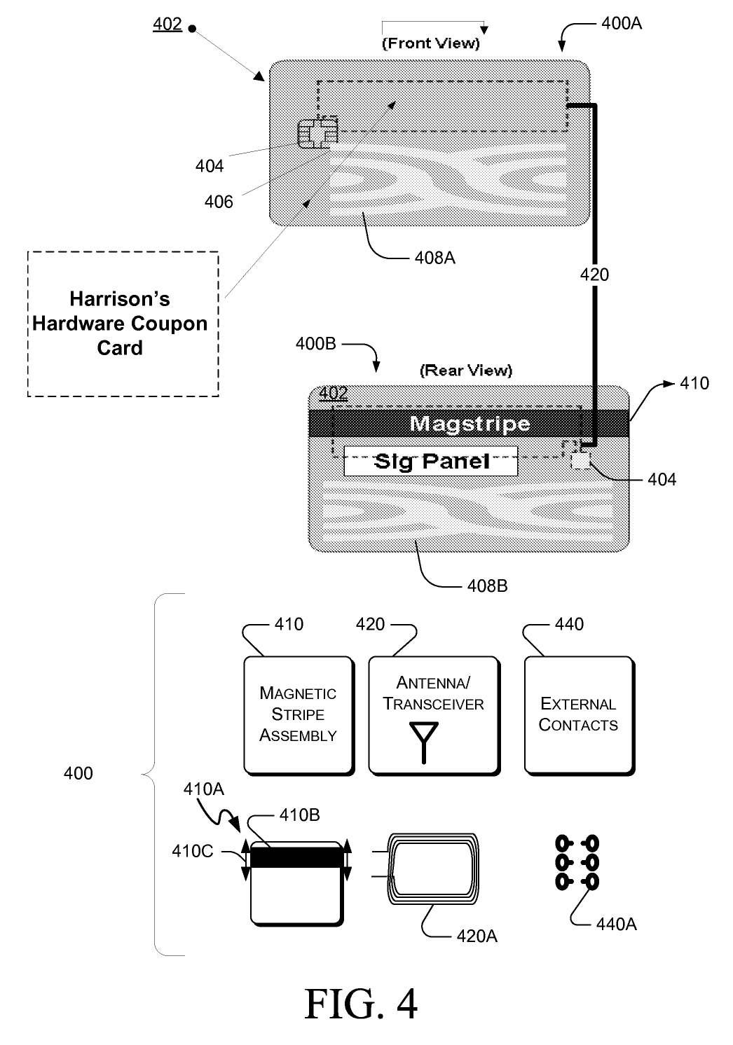

Turning to FIG. 4, both a front view 400A and a rear view 400B of a coupon card 402 are presented. Images may be displayed on both sides of coupon card 402, with image 408A on the front view 400A being either the same as or different from image 408B on the rear view 400B. In this illustration, the front view 400A also displays information about the provider of the coupon card.

FIG. 4 also shows exemplary implementations of a data encoding area of coupon card 402. The data encoding area may include an optional shielding element, which allows desired electromagnetic, optical, or radiative signals to penetrate while protecting the data encoding area from physical abuse or damage. Coupon card 402 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not by way of limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 400, and include a magnetic stripe assembly 410, an antenna and/or transceiver 420, and electrical contacts 440. Magnetic stripe assembly 410 may comprise, in one implementation 410A, a reprogrammable magnetic stripe 410B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 410, rendering the card useless in the event of its loss or theft. In one implementation shown 410A, magnetic stripe assembly 410B at least partially slidably moves 410C into and out of an assembly of coupon card 402 (partial view shown), allowing coupon card 402 to conduct a transaction at a point of sale terminal that includes a magnetic stripe reader.

Continuing with FIG. 4, another implementation of the data encoding area is shown as an antenna and/or transceiver 420. Antenna and/or transceiver 420 may include commonly used loop inductors such as the one shown 420A or in those shown in related ISO standards for RF-readable smart cards. With such an interface, account data may be translated, modulated and transmitted in a manner acceptable by an RF contactless merchant POS terminal, a 802.11 WiFi or WiMax network, or by a cellular or RF communications network. For instance, antenna and/or transceiver 420 may receive a wireless communication from a kiosk, where the wireless communication carries a manufacturer's discount coupon account that is to be written in memory to the data encoding area 400.

Electrical contacts 440 are yet another alternative implementation of the data encoding area shown in FIG. 4. With coupon card 402 possessing physical contacts such as an array of conductive pads or shapes 440A, coupon card 402 may be placed in physical contact with a merchant POS terminal, and electrical contacts 440 may establish connectivity to the merchant's financial processing system. The processor may relay account-related information to the merchant POS terminal through the contact interface, thereby allowing coupon card 402 to be utilized with the large number of preexisting merchant POS terminals.

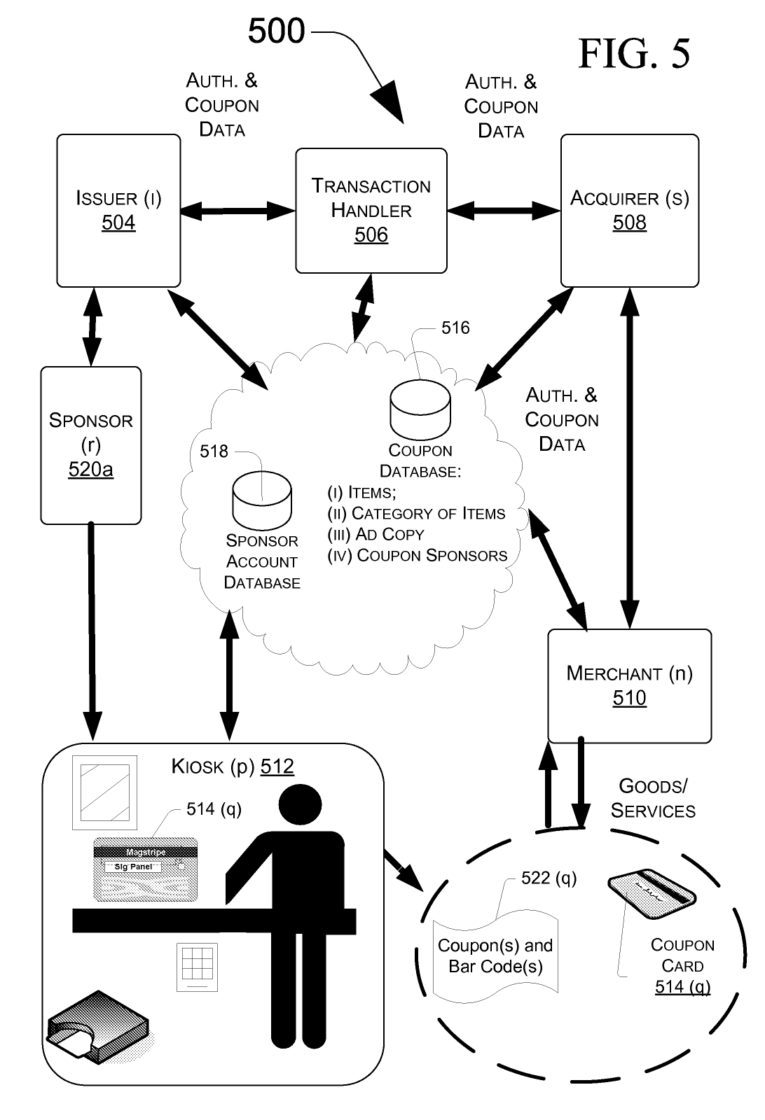

Within the exemplary payment processing system depicted in FIG. 1, FIG. 5 illustrates the general environment wherein a coupon card may be used by a consumer to obtain a discount on the purchase of goods and services. To start, consumer 502 selects a coupon that is to encoded on and/or into an enhanced coupon card 514(q) that is dispensed to consumer 502 by a kiosk (p) 512. Consumer 502 presents to merchant 510 the coupon card 514(q). The information stored on coupon card 514(q) is read to determine the third-party account associated with the electronic coupon being used to conduct the transaction between consumer 502 and the merchant 510. In certain implementations, coupon card 514(q) is read by RFID when consumer 502 is near the POS terminal (a ‘contactless’ transaction). In other implementations, a magstrip of coupon card 514(q) is read being swiped through a magstrip reader in communication with the POS terminal. In still other implementations, coupon card 514(q) is read by being inserted into the POS terminal such that external contacts on coupon card 514(q) establish connectivity with the POS terminal that facilitate the reading of memory therein.

In certain implementations, other information is also read from coupon card coupon card 514(q), such as, without limitation, an expiration date, an item type, or an item quantity. In such implementations, the POS terminal may determine whether the electronic coupon is valid for an item being purchased by consumer 502. This may occur, by way of example and not limitation, by comparing the current date with the expiration data of the electronic coupon. Alternatively, the POS terminal may determine whether consumer 502 has purchased the quantity of the discounted item specified.

In certain implementations, consumer 502 provides Print-out 522 to merchant 510. Print-out 522 includes a bar code printed thereon which identifies the item eligible for a discount using the electronic coupon stored on coupon card 514. In such an implementation, the bar code is scanned with a scanner to identify the item that is eligible for the discount. In certain implementations, merchant 510 additionally enters the amount of the discount into the POS terminal.

In certain implementations, coupon card 514(q) may be a one-time use card. In such an implementation, merchant 510 may forgo returning coupon card 514(q) to consumer 502. In other implementations, coupon card 514(q) may be used to store subsequent electronic coupons obtained using kiosk 512, and therefore is returned to consumer 502.

Upon receipt of coupon card 514(q), the transaction is processed similarly to the method previously described in connection with FIG. 1. Merchant 510 submits the authorization request to acquirer 508. Where acquirer 508 is not the same entity as issuer 504, acquirer 508 forwards the transaction information to a transaction handler 506, who in turn forwards it to issuer 504 to verify that the account associated with the sponsor of the coupon contains sufficient funds to reimburse merchant 510 for the discount. Upon receipt of a reply from issuer 504, transaction handler 506 forwards an authorization response to acquirer 508, who forwards it to merchant 510. Where the authorization response contains an approval of the use of the electronic coupon, consumer 502 is given a discount on the retail purchase price of the item. In certain implementations, merchant 510 additionally invalidates or deletes the electronic coupon stored on coupon card 514

In certain implementations, approval of the transaction may be more involved. In such implementations, the authorization request includes additional information, by way of example and not limitation, the item, the item type, and/or the sponsor of the electronic coupon. In one implementation, database 516 may be used to, by way of example and not limitation, verify that electronic coupon sponsor 520 has issued the electronic coupon that consumer 502 is attempting to use. In such an implementation, the authorization process may include comparing the additional information provided against information stored in database 516. In other implementations, database 516 is used to keep a tally of the electronic coupons used by consumers. In such an implementation, this information may then be used by electronic coupon sponsor 520 in deciding future electronic coupons to issue or for identifying specific consumers for targeted advertising. In still other implementations, the additional information includes an identifier for the advertisement that was presented to consumer 502 with the electronic coupon being used. In such an implementation, electronic coupon sponsor 520 may charge another entity a fee for each time the advertisement is shown to consumers. Alternatively, electronic coupon sponsor 520 may change the advertisement associated with an electronic coupon after the advertisement has been presented with the electronic coupon a given number of times.

In other implementations, database 518 is used. Database 518 may contain information regarding the account issued to each coupon sponsor 520(r), where electronic coupon sponsor 520(r) is one of (R) coupon sponsors. In such implementations, database 518 may be used to verify that the account identifier read from coupon card 514 is associated with one of the (R) electronic coupon sponsors. Database 518 may additionally be used to verify that the associated account contains funds sufficient to reimburse merchant 510 for the discount applied.

When merchant 510 submits the transaction to payment processing system 500 for clearing and settlement, the account of the sponsor of the coupon is deducted for the cost of the discount. Specifically, merchant 510 submits a request for payment to acquirer 508. Where acquirer 508 is not the same entity as issuer 504, acquirer 508 forwards the request to transaction handler 506. Transaction handler 506 in turn requests payment for the discount from issuer 504, where issuer 504 is the issuer of the account associated with the sponsor of the coupon. Issuer 504 deducted the amount of the discount from the account and forward the payment to transaction handler 506 who forwards the payment to acquirer 508. Finally, acquirer 508 adds the amount of the discount to the account of merchant 510. As such, the merchant has been compensated for the amount of the discount given to the consumer.

As an example of how the described coupon card may used, a consumer may take a coupon card with them to the grocery store. While at the grocery store, the consumer uses a kiosk inside the grocery store to obtain an enhancement to their coupon card so as to have selected electronic coupons stored thereon. The consumer uses the kiosk's interface to select specific electronic coupons they want to use, for example one for bread offered by the manufacturer of the bread, and one for pet food offered by the grocery store the consumer is shopping at. The electronic coupons and associated information are then written to the coupon card by the kiosk. The kiosk then dispenses the coupon card and an accompanying print-out of bar codes and identifying information for each such selected coupon and corresponding discount. While the consumer is shopping, the consumer can use the print-out to remember what coupons are stored on the coupon card.

At the check-out counter, the consumer provides the coupon card and a print-out of bar codes to the cashier. The cashier swipes the magnetic strip of the coupon card through the POS terminal (or interrogates a smart coupon card with a contactless reader) and scans the bar codes on the print-out. The cashier then scans the SKU/UPCs (Stock-Keeping Unit/Universal Product Code) for each item the consumer is purchasing.

The POS terminal determines if the electronic coupons apply to any of the items being purchased by comparing the bar codes with the scanned SKU/UPCs. For example, the coupon card may contain multiple electronic coupons, one of which is for a discount on bread and is provided by the manufacturer of the bread. Another electronic coupon, that is provided by the grocery store, may be for a discount on pet food. When the POS terminal receives the SKU/UPCs for a loaf of bread and a bag of pet food, the POS terminal requests authorization to apply a discount to those two (2) items. The authorization request is, for example, received by the grocery store's acquirer.

As the acquirer is the issuer of the account associated with the grocery store, the acquirer verifies if the account for the sponsor of the discount has sufficient funds to pay for the discount on the pet food and sends an authorization response to the POS terminal. The request for authorization to apply a discount to the bread is forwarded by the acquirer to a transaction handler for processing. The transaction handler in turn may forward a request to the issuer of the manufacturer's account for verification that the account contains sufficient funds. Upon receiving a response, the transaction handler may send an authorization response authorizing the application of the discount to the bread.

Once the POS terminal receives the authorization responses for both coupons, the discounts are applied. The consumer may then also use the coupon card to pay for the items, where the coupon card is associated with an account of the consumer's (i.e., the credit card or the debit card of the consumer which has been enhanced by a kiosk so as to also contain discount coupon information used in the transaction at the merchant's POS), or the consumer may use an alternative payment method (cash, checks, food stamps, etc.)

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The steps of a method, process, or algorithm described in connection with the implementations disclosed herein may be embodied directly in hardware, in a software module executed by a processor, or in a combination of the two. In certain implementations, instructions are encoded in computer readable medium wherein those instructions are executed by a processor to perform one or more of the steps recited.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a method of providing an electronic coupon to a user of a kiosk comprising:
receiving, using an input device of a user interface, a selection of at least one electronic coupon from a database having a plurality of said electronic coupons each:
being associated with a sponsor account issued to a sponsor of a discount by an issuer; and
for being receivable by one said merchant to give the discount on a purchase, wherein the discount is to be debited from the sponsor account and credited to one said merchant account issued by another said issuer to the one said merchant to reimburse the one said merchant for the discount;
retrieving, from the database:
a rendering image corresponding to the rendering capabilities of the kiosk;
a memory location to store discount information in a memory of a type of portable coupon device stored within the kiosk; and
the discount information including an identifier for:
the sponsor account;
a discount amount; and
the purchase eligible for the discount from the one said merchant and including at least one of a good and service;
writing, to the memory location in the memory of the portable coupon device the discount information;
dispensing the portable coupon device;
and
rendering a hard copy of the rendering image.

2. The method of claim 1, further comprising:
receiving a consumer identifier; and
displaying, using the user interface, a portion of the plurality of electronic coupons based upon the consumer identifier.

3. The method of claim 1, wherein said retrieving further comprises connecting to a network, wherein the database is stored on the network.

4. The method of claim 1, wherein the rendering image includes a bar code identifying the purchase, wherein said rendering further comprises printing a print-out of the bar code that is capable of being scanned by a scanner at a Point of Service terminal.

5. The method of claim 1, further comprising displaying, using the user interface, an advertisement associated with at least one of the plurality of electronic coupons.

6. The method of claim 1, wherein the rendering image includes an advertisement to be printed on the portable coupon device, the method further comprising printing the advertisement on the portable coupon device.

7. The method of claim 1, wherein the sponsor account is issued to a member of the group comprising:
the merchant selling the purchase;
a manufacturer of the purchase;
a wholesaler of the purchase; and
a distributor of the purchase.

8. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a kiosk comprising:
a user interface capable of displaying at least one electronic coupon from a database having a plurality of said electronic coupons each:
being associated with a sponsor account issued to a sponsor of a discount by an issuer; and
for being receivable by one said merchant to give the discount on a purchase, wherein the discount is to be debited from the sponsor account and credited to one said merchant account issued by another said issuer to the one said merchant to reimburse the one said merchant for the discount;
an input device capable of receiving a selection of at least one electronic coupon from the database;
a means for retrieving from the database:
a rendering image corresponding to the rendering capabilities of the kiosk;
a memory location to store discount information in a memory of a type of portable coupon device stored within the kiosk; and
the discount information including an identifier for:
the sponsor account;
a discount amount; and
the purchase eligible for the discount from the one said merchant and including at least one of a good and service;
a means for writing, to a memory location in a memory of a portable coupon device, the discount information;
a means for dispensing the portable coupon device;
and
a means for rendering a hardcopy of the rendering image.

9. The kiosk of claim 8, further comprising a means for receiving a consumer identifier for use in displaying, using the user interface, a portion of the plurality of electronic coupons based upon the consumer identifier.

10. The kiosk of claim 8, wherein said means for retrieving includes a means for communicating with a network, wherein the database is stored on the network.

11. The kiosk of claim 8, wherein the rendering image includes a bar code identifying the purchase, wherein the means for rendering is capable of printing a print-out of the bar code that is scanable by a scanner at a Point of Service terminal.

12. The kiosk of claim 8, wherein the user interface is capable of streaming an advertisement associated with at least one of the plurality of electronic coupons.

13. The kiosk of claim 8, further comprising a means for printing an advertisement on the portable coupon device.

14. The kiosk of claim 8, wherein the sponsor account is issued to a member of the group comprising:
the merchant selling the purchase;
a manufacturer of the purchase;
a wholesaler of the purchase; and
a distributor of the purchase.

15. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a method of using a kiosk to obtain a portable coupon card having an electronic coupon stored thereon, the method comprising:
selecting, using an input device of a user interface, at least one electronic coupon from a database having a plurality of said electronic coupons:
being associated with a sponsor account issued to a sponsor of a discount by an issuer; and
for being receivable by one said merchant to give the discount on a purchase, wherein the discount is to be debited from the sponsor account and credited to one said merchant account issued by another said issuer to the one said merchant to reimburse the one said merchant for the discount;
and
receiving from the kiosk:
a portable coupon device having discount information stored in a memory, the discount information including an identifier for:
the sponsor account;
a discount amount;
the purchase that is eligible for the discount from the merchant and including at least one of a good and a service;
and
a hard copy of a rendering image corresponding to the rendering capabilities of the kiosk.

16. The method of claim 15, further comprising:
providing a consumer identifier; and
viewing, using the user interface, a portion of the plurality of the electronic coupons based upon the consumer identifier.

17. The method of claim 15, wherein the rendering image includes a bar code identifying the purchase, the method further comprising receiving a print-out of the bar code that is scanable by a scanner at a Point of Service terminal.

18. The method of claim 15, further comprising viewing, using the user interface, an advertisement associated with at least one of the plurality of electronic coupons.

19. The method of claim 15, wherein the sponsor account is issued to a member of the group comprising:
the merchant selling the purchase;
a manufacturer of the purchase;
a wholesaler of the purchase; and
a distributor of the purchase.

20. The method of claim 15, wherein the portable coupon device received includes an advertisement printed on the portable coupon device.
